(19) United States
(12) Patent Application Publication
(10) Pub. No.: US 2011/0154416 A1
(43) Pub. Date: Jun. 23, 2011

(54) UNIFIED VIDEO-ON-DEMAND SERVICE SYSTEM

(75) Inventor: Jeong Yun KIM, Daejeon (KR)

(73) Assignee: Electronics and Telecommunications Research Institute, Daejeon (KR)

(21) Appl. No.: 12/860,725

(22) Filed: Aug. 20, 2010

(30) Foreign Application Priority Data
Dec. 21, 2009 (KR) 10-2009-0128427

(51) Int. Cl. H04N 7/173

(52) U.S. Cl. 725/98

(57) ABSTRACT

A unified VoD service system includes an interworking gateway that is positioned between a video server providing video in a PDL scheme (or streaming scheme) and a plurality of user terminals requesting the video in different schemes (e.g., PDL scheme or streaming scheme). The video is provided even to the user terminal requesting the video in a scheme that is different from the video server by using the interworking gateway.

### CROSS-REFERENCE TO RELATED APPLICATION

This application claims priority to and the benefit of Korean Patent Application No. 10-2009-0128427 filed in the Korean Intellectual Property Office on Dec. 21, 2009, the entire contents of which are incorporated herein by reference.

### BACKGROUND OF THE INVENTION

(a) Field of the Invention

The present invention relates to a unified video-on-demand service system providing both a streaming scheme and a progressive download scheme at the time of providing a video-on-demand service to a user.

(b) Description of the Related Art

A known video-on-demand service primarily uses a streaming scheme in which a VoD server (i.e., video server) transmits video in real time to suit a playing speed of a terminal and the terminal receives and plays the video. Meanwhile, a download and play (DNP) scheme is a VoD service in which the terminal downloads all video contents required for playing and thereafter starts to play the contents.

A progressive download (PDL) scheme or a hypertext transfer protocol (HTTP) streaming scheme that are recently being used has advantages of both the streaming scheme and the DNP scheme such as real-time performance of the streaming scheme and high-quality playing of the DNP scheme. That is, the PDL scheme can start to play the video by using video meta-information while downloading the video. Further, the PDL scheme can transmit high-quality video suitable for a network environment at high speed by using a characteristic of a transmission control protocol (TCP).

According to recent Internet traffic statistical data, 70% of video traffic is transmitted by the DNP scheme or the PDL scheme using the HTTP and the transmission control protocol (TCP), and only the remaining approximately 30% of video traffic is transmitted by the streaming scheme using a real time streaming protocol (RTSP), a real-time transport protocol (RTP), and a user datagram protocol (UDP).

As described above, since the streaming scheme and the PDL scheme are different from each other in the used protocol and service providing method, they are implemented as independent systems.

Therefore, an IPTV service provider incurs much cost in order to construct and administrate two systems. In recent years, Internet technologies such as the web, HTTP, etc. have been remarkably developed, and it is expected that the streaming scheme will gradually switch to the PDL scheme such that integration of the two systems will be on the rise as an important issue.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a unified video-on-demand service system having advantages of supporting two schemes (streaming scheme and PDL scheme) irrespective of a VoD service scheme that a user requests.

An exemplary embodiment of the present invention provides a unified VoD service system including: a video server providing video that a user terminal requests; and an interworking gateway that is positioned on a transmission path between the user terminal and the video server to interwork the video request transmitted from the user terminal to the video server regarding a control message, transmit video received from the video server to the user terminal, and interwork between a protocol used in the video server and a protocol used in the user terminal regarding the video.

### BRIEF DESCRIPTION OF THE DRAWINGS

FIG. 1 is a network configuration diagram of a unified VoD service system according to an embodiment of the present invention;

FIG. 2 is a diagram illustrating an operation of a unified VoD service system according to a second embodiment of the present invention; and

FIG. 3 is a diagram illustrating an operation of a unified VoD service system according to a second embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Hereinafter, a unified VoD service system according to an embodiment of the present invention will be described in detail with reference to the accompanying drawings.

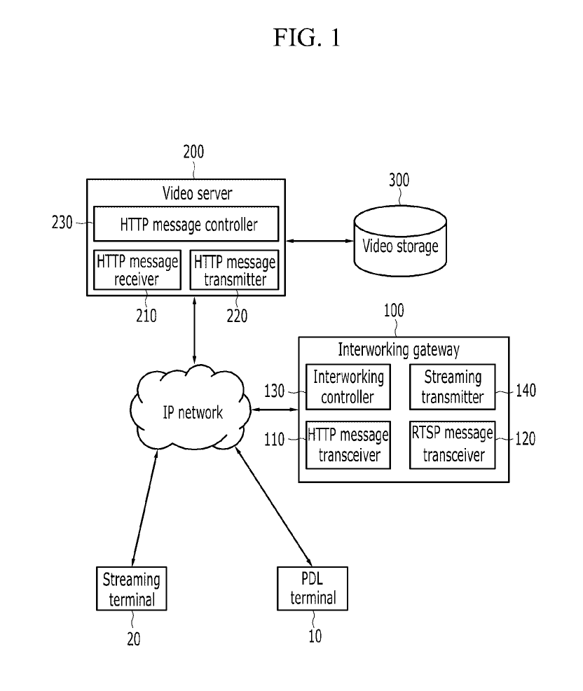

FIG. 1 is a network configuration diagram of a unified VoD service system according to an embodiment of the present invention and illustrates a case where a VoD server, i.e., a video server 200, supports a PDL scheme.

As shown in FIG. 1, the unified VoD service system according to the embodiment of the present invention includes a PDL terminal 10, a streaming terminal 20, an interworking gateway 100 that is a protocol converter, a video server 200, and a video storage 300.

The PDL terminal 10 requests a VoD service on the basis of an HTTP protocol and plays video by supporting a PDL scheme, and the streaming terminal 20 requests the VoD service on the basis of an RTSP protocol and plays the video in a streaming scheme.

The video server 200 provides video that a user requests to the interworking gateway 100 through the HTTP protocol in accordance with the PDL scheme by interworking with the interworking gateway 100.

The video server 200 includes an HTTP message receiver 210, an HTTP message transmitter 220, and an HTTP message controller 230 in order to provide the VoD service of the PDL scheme.

The HTTP message receiver 210 receives an HTTP message requesting the video from the interworking gateway 100, and the HTTP message transmitter 220 transmits the video to the interworking gateway 100 from the interworking gateway 100 through the HTTP protocol. The HTTP message controller 230 identifies (grasps) the video that the user requests from the HTTP message received from the HTTP message receiver 210, and reads the corresponding video from the video storage 300 and provides it to the HTTP message transmitter 220.

The interworking gateway 100 is positioned on a communication path of the user terminal (e.g., PDL terminal and streaming terminal) and the video server to perform a function as the user terminal for the video server 200 and a function as the video server 200 for the user terminal. That is, the interworking gateway 100 synchronizes (that is, interworks) protocols between the terminals 10 and 20 and the video server 200.

The interworking gateway 100 has an internal configuration including an HTTP message transceiver 110, an RTSP message transceiver 120, an interworking controller 130, and a streaming transmitter 140.

The HTTP message transceiver 110 takes charge of transmitting and receiving the HTTP message to and from the PDL terminal 10, and takes charge of transmitting and receiving the HTTP message to and from the video server 200 of the PDL scheme.

The RTSP message transceiver 120 takes charge of transmitting and receiving an RTSP message to and from the streaming terminal 20 requesting the video through the RTSP protocol.

The interworking controller 130 grasps the protocol (e.g, HTTP protocol) depending on the video transmission scheme (PDL scheme) used in the video server 200 and converts the video request message of each of the terminals 10 and 20, which is received from the HTTP message transceiver 110 and the RTSP message transceiver 120, into the HTTP protocol that matches with the video server 200.

In addition, when the interworking controller 130 receive the HTTP message including the video from the video server 200, the interworking controller 130 extracts only the video from the HTTP message and provides it to the streaming transmitter 140 to cache it, and provides the cached video as the HTTP message or the video stream in accordance with the video supporting scheme of the terminals 10 and 20.

The streaming transmitter 140 caches the video received from the interworking controller 130 and provides the cached video to the streaming terminal 20 in accordance with the streaming scheme. Meanwhile, the streaming transmitter 140 stores all or some of the cached videos from the video server 200 and provides the video to a user terminal (i.e., streaming terminal).

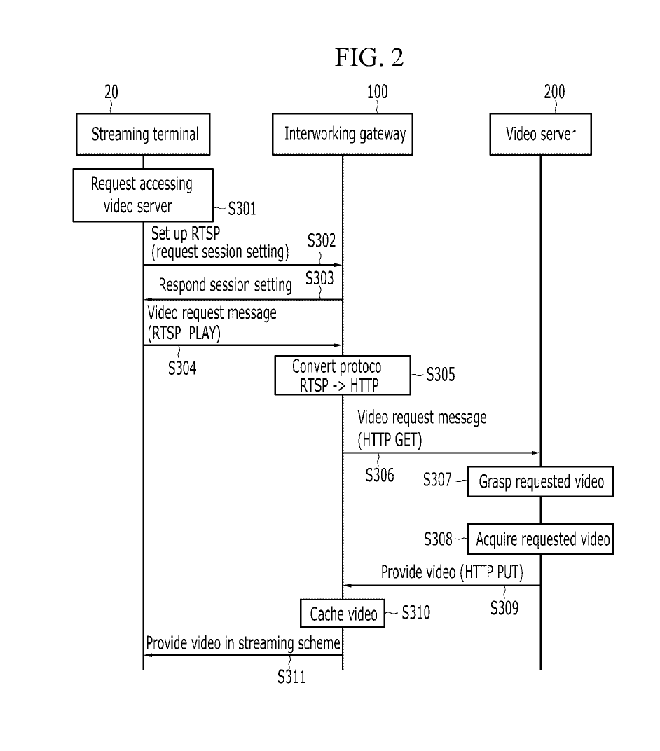

Hereinafter, referring to FIG. 2, an operation of a unified VoD service system according to a first embodiment of the present invention will be described. FIG. 2 is a diagram illustrating an operation of a unified VoD service system according to a first embodiment of the present invention, and illustrates a case where the VoD service is provided to a streaming terminal 20 on the basis of the unified VoD service system according to the embodiment of the present invention shown in FIG. 1.

When a user requests access to the video server 200 (S301), a streaming terminal 20 transmits an RTSP SETUP message for session setting with the video server 200 to the video server 200 (S302).

At this time, the RTSP SETUP message transmitted from the streaming terminal 20 is actually received into an interworking gateway 100 instead of the video server 200.

The interworking gateway 100 sets a session with the streaming terminal 20 in accordance with the RTSP SETUP message, and transmits a response message notifying the session setting to the streaming terminal 20 (S303).

When the session is set with the interworking gateway 100, the streaming terminal 20 requests the video request message (RTSP PLAY message) for the video that the user wants through the set RTSP session (S304).

Therefore, the interworking gateway 100 receives the video request message through the RTSP message transceiver 120 and converts the protocol of the video request message into the HTTP protocol through the interworking controller 130 for interworking with the video server 200 (S305).

Thereafter, the interworking gateway 100 transmits the video request message converted into the HTTP protocol to the video server 200 (S306).

The video server 200 receives the video request message transmitted from the interworking gateway 100 through the HTTP message transmitter 210, and grasps which video the user requests, which is included in the video request message, through the HTTP message controller 230 (S307).

In addition, the video server 200 acquires the grasped video from a video storage (S308) and provides the video acquired through the HTTP message transmitter 220 to the interworking gateway 100 (S309).

When the interworking gateway 100 receives the HTTP message including the video through the HTTP message transceiver 110, the interworking gateway 100 caches the video included in the HTTP message to the streaming transmitter 140 by verifying that the terminal that the user terminal requesting the video is the streaming terminal 20 (S310).

Thereafter, the interworking gateway 100 transmits the video cached through the streaming transmitter 140 to the streaming terminal 20 in accordance with the streaming scheme (S311).

Therefore, as described above, the streaming terminal 20 requests and receives the video that the user requests from the video server 200 having a different video transmission scheme to play the video.

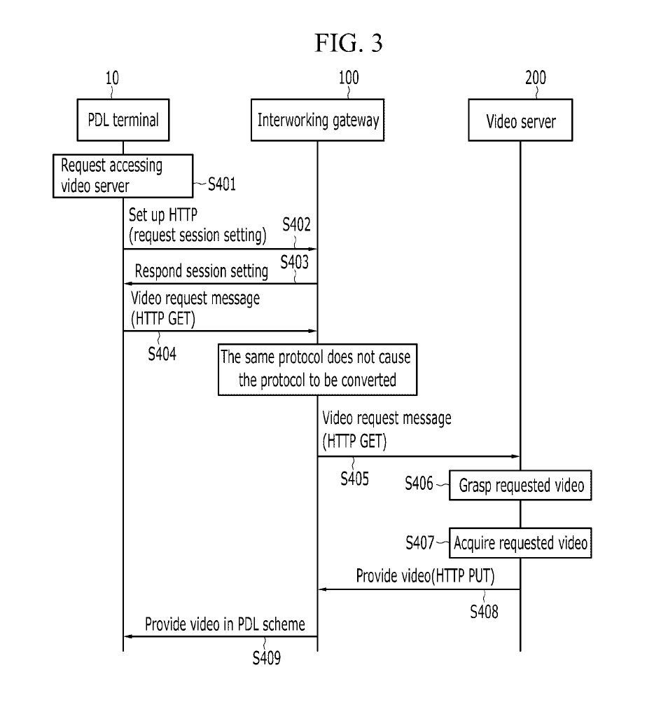

Hereinafter, referring to FIG. 3, an operation of a unified VoD service system according to a second embodiment of the present invention will be described. FIG. 3 is a diagram illustrating an operation of a unified VoD service system according to a second embodiment of the present invention, and illustrates a case where the VoD service is provided to the PDL terminal 10 on the basis of the unified VoD service system according to the embodiment of the present invention shown in FIG. 1.

When the user requests access to the video server 200 (S401), the PDL terminal 10 preferentially transmits a session setting request message (e.g., HTTP SETUP message) for session setting with the video server 200 to the video server 200 in order to request a service by using the HTTP protocol (S402).

At this time, the session setting request message is actually received into the interworking gateway 100 instead of the video server 200.

The interworking gateway 200 sets the session with the PDL terminal 10 in accordance with the received session setting request message, and transmits the response message notifying the session setting to the PDL terminal 10 (S403).

After the session with the interworking gateway 100 is set, the PDL terminal 10 requests the video request message (HTTP GET message) requesting the video that the user wants through the set session (S404).

Therefore, the interworking gateway 100 receives the video request message through the HTTP message transceiver 110, and since the interworking gateway 100 uses the same protocol as the protocol used in the video server 200, the interworking gateway 100 transmits the received video request message to the video server 200 without additional protocol conversion (S405).

The video server 200 receives the video request message transmitted from the interworking gateway 100 through the HTTP message transmitter 210 and grasps which video the user requests, which is included in the video request message, through the HTTP message controller 230 (S406).

In addition, the video server 200 acquires the grasped video from the video storage (S407) and provides the video acquired through the HTTP message transmitter 220 to the interworking gateway 100 (S408).

When the interworking gateway 100 receives the video through the HTTP message transceiver 110, the interworking gateway 100 verifies that the user terminal that requests the video is the PDL terminal 10, and just provides the HTTP message including the video to the PDL terminal 10 (S409).

As described above, in the second embodiment of the present invention, since the PDL terminal 10 and the video server 200 use the same protocol, protocol interworking in the interworking gateway 100 is not required.

Meanwhile, in the second embodiment of the present invention, as the video provided by the video server 200 is provided by the same protocol as the protocol of the user terminal (e.g., PDL terminal), the interworking gateway 100 directly transmits the video to the PDL terminal without caching.

However, the present invention is not limited thereto, and even though the video provided by the video server 200 is transmitted by the same protocol as the protocol of the user terminal, the video can be cached. At this time, the interworking gateway 100 provides the video caching instead of the video server 200 when the user requests the same video afterwards to provide a quick video service.

Further, in the first and second embodiments, the video server 200 performs an operation for protocol interworking between the terminals 10 and 20 and the video server 200 to correspond to the case where the video server 200 uses the PDL scheme (e.g., HTTP protocol).

However, the present invention is not limited thereto, and the interworking gateway 100 may perform the operation for the protocol interworking between the terminals 10 and 20 and the video server 200 to correspond to the case where the video server 200 provides the video by using the streaming scheme (e.g., RTSP protocol), such that the PDL terminal 10 receives the video from the video server 200. Since those skilled in the art can easily implement another embodiment of the present invention through the described embodiments with reference to FIGS. 1 to 3, a further description thereof will be omitted.

According to an embodiment of the present invention, by using a VoD server that supports both a streaming scheme and a PDL scheme by using an inter-working gateway in a subscriber band and transmitting video at a higher speed than a playing speed of a terminal device by using the PDL scheme in a backbone network band and an interworking gateway caching and transmitting the video to the terminal device in real time, it is possible to smoothly switch the streaming scheme to the PDL scheme while saving investment cost of an IPTV provider.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A unified VoD service system providing a service to first and second terminals requesting video by using different protocols, comprising:
a video server providing video that a user terminal requests; and
an interworking gateway that is positioned on a transmission path between the user terminal and the video server to interwork the video request transmitted from the user terminal to the video server regarding a control message, transmit video received from the video server to the user terminal, and interwork a protocol used in the video server and a protocol used in the user terminal regarding the video.

2. The system of claim 1, wherein
the interworking gateway includes,
when the video server uses a data transmission scheme based on a first protocol:
a first protocol message transceiver that takes charge of transmitting and receiving a first protocol message;
a second protocol message transceiver that takes charge of transmitting and receiving a second protocol message;
an interworking controller that converts the second protocol message of the user terminal received in the second protocol message transceiver into the specification of the first protocol and transmits it to the video server and transmits first video to be provided to the first terminal from the first video server, which is received through the first protocol message transceiver on the basis of the first protocol; and
a streaming transmitter that caches the first video in accordance with a direction from the interworking controller and provides the cached first video to the first terminal on the basis of the first protocol.

3. The system of claim 2, wherein
the interworking controller transmits the received message without performing the protocol conversion with respect to it when the user terminal and the video server use the same protocol.

4. The system of claim 3, wherein
the first protocol is a real-time streaming protocol (RTSP) and the second protocol is a hypertext transfer protocol (HTTP).

5. The system of claim 3, wherein
the first protocol is a hypertext transfer protocol (HTTP) and the second protocol is a real-time streaming protocol (RTSP).
